(19) United States
(12) Patent Application Publication
(10) Pub. No.: US 2003/0024483 A1
(43) Pub. Date: Feb. 6, 2003

(54) Whelping pen

(76) Inventor: Jeanne Pederson, Brookfield, WI (US)

Correspondence Address: Willis B. Swartwout III, 617 Oxford Drive, P.O. Box 619, Hartland, WI, 53029-0619, US

(21) Appl. No.: 09/920,283

(22) Filed: Aug. 2, 2001

(51) Int. Cl. A01K 1/00

(52) U.S. Cl. 119/513

(57) ABSTRACT

The present invention is an improved whelping pen, formed from disposable materials and in a scored blank to have elongated side and end walls adapted to be folded to form the pen and to engage the side and end walls. The side and end walls are adapted to be covered by an elongated peaked roof engageable with said walls and adapted to support a drape to cover the interior elongated walls and floor and to be clamped to said walls in a temporarily secured manner for easy removal and disposal. Said wall and floor material impregnated with a moisture resistant chemical to prevent absorption of urine. One of said walls provided with an aperture to permit the mother to enter and leave the pen.

### BACKGROUND OF THE INVENTION

The present invention relates to pens within which primarily domesticated animals may give birth to their young. In the far past it was the usual custom for pet owners to build whelping pens with wood bottoms and sides and linoleum floors or the like, and an entrance for the female to enter the pen from time to time to feed and care for her young.

Often the floor of the pen was lined with newspapers or other paper products so that from time to time the soaked up urine and feces could be disposed of and the floor sterilized with an appropriate product to deodorize and clean the pen. The entry opening level would progressively be raised so that the young could not leave. The pen would be saved after the litter was raised and taken apart to be re-used at another time. However, this often created storage problems for a bulky item.

Over the years there have been various attempts at disposable or temporary whelping pens with varying degrees of success. However, nothing has been completely satisfying to breeders of small animals and dogs. One of the significant problems is the cost on those boxes or pens in terms of throwing them away after one use and the complexity of erecting and disassembling them.

### SUMMARY OF THE INVENTION

The present invention is a whelping pen or box which is easily assembled and disassembled and overcomes the problems previously described.

The present invention is a whelping pen or box of the character above described wherein the pen or box is constructed of heavy duty cardboard, scored and slotted for easy folding and assembly.

The present invention proposes to provide a pen or box of the character above describes made from heavy duty cardboard, scored for ease in folding and impregnated with moisture proofing sealer to resist absorption of urine and feces.

The present invention proposes to provide a pen or box of the character above described wherein the structural walls, floor, cover or other structural members may be provided with tabs and slots to receive the tabs for easy joinder.

The present invention proposes to provide structure of the character above described wherein a pen or box and the structural walls are formed from a single cardboard unit scored for easy folding into the pen or box structure.

The present invention proposes to provide structure of the character above described wherein said unit is provided with disposable material to line the bottom.

The present invention proposes to provide structure of the character above described wherein decorative structure is provided for the tops of the side walls which also serve to suspend and secure the disposable material used to line the bottom and side walls.

Various other objects and advantages will become known as this description proceeds as will various modifications and changes which can be made without departing from the spirit of the invention. It is intended that these various objects, advantages, modifications and changes shall be covered by the scope of the appended claims.

### BRIEF DESCRIPTION OF THE DRAWINGS

FIG. 1 is a layout in plan view of foldable structure embodying the present invention;

FIG. 2 is an isometric view of the structure shown in FIG. 1 and assembled and folded, showing the cover and functional decorative structure;

FIG. 3 is an end view of the structure of FIGS. 1 and 2 showing details of construction; and

FIG. 4 is a top plan view of the cover or roof showing details of construction.

### DESCRIPTION OF THE PREFERRED EMBODIMENT

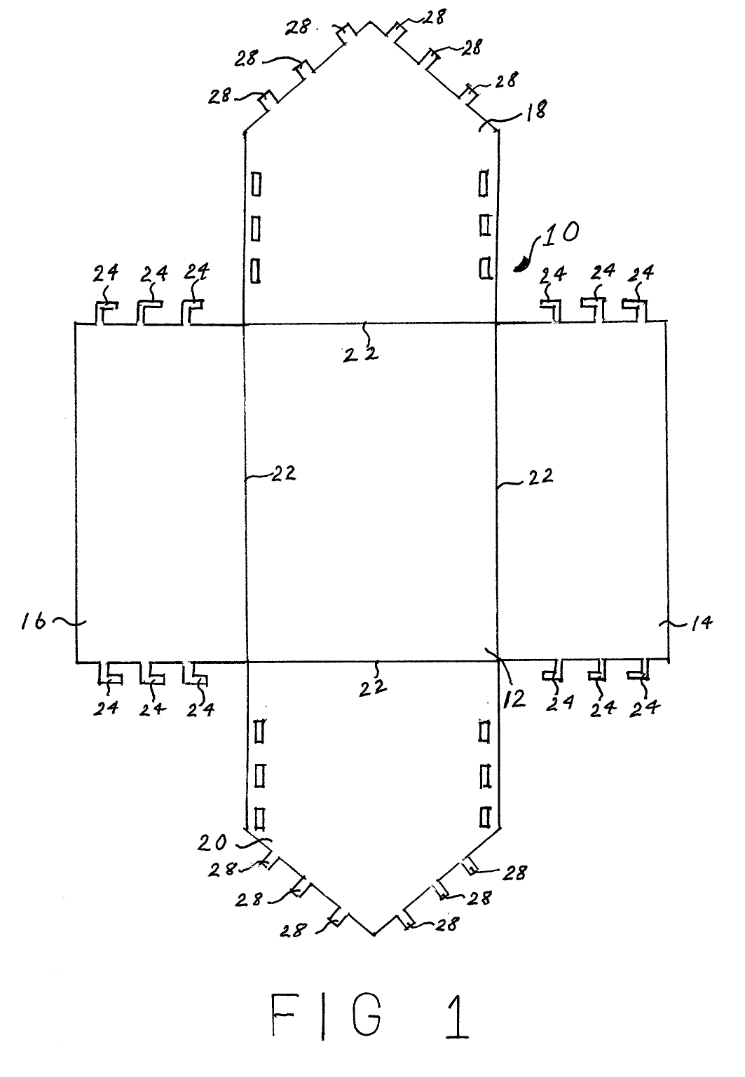

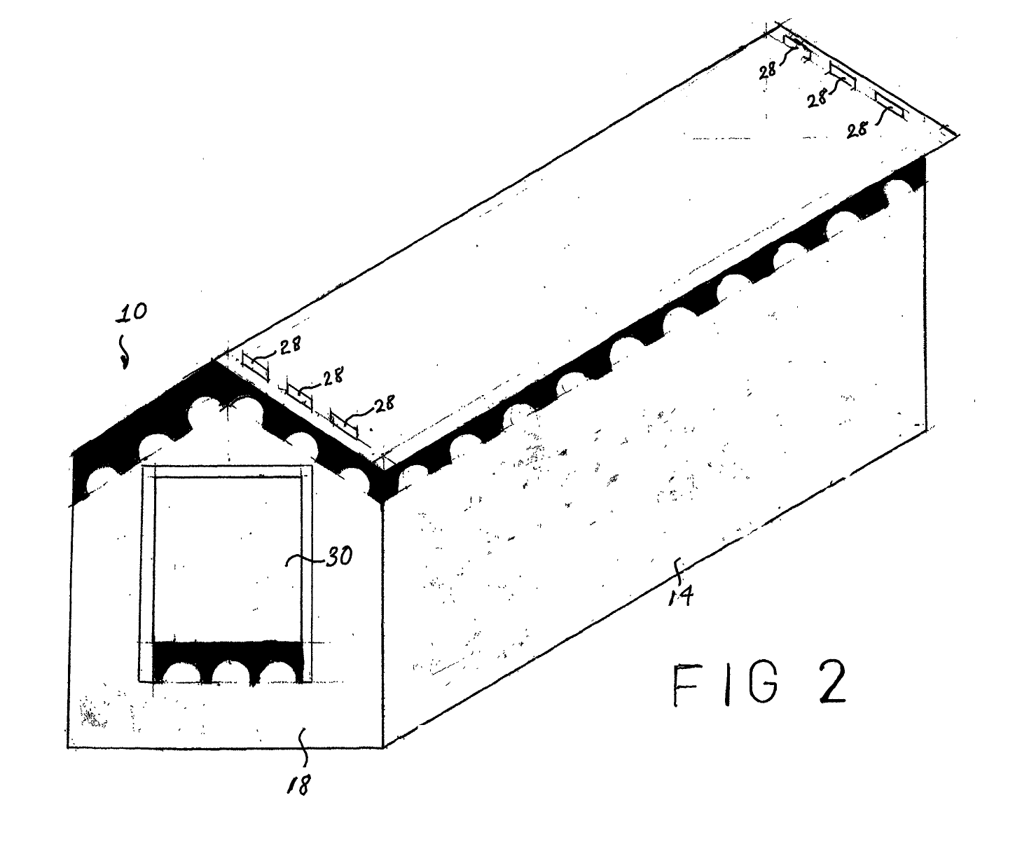

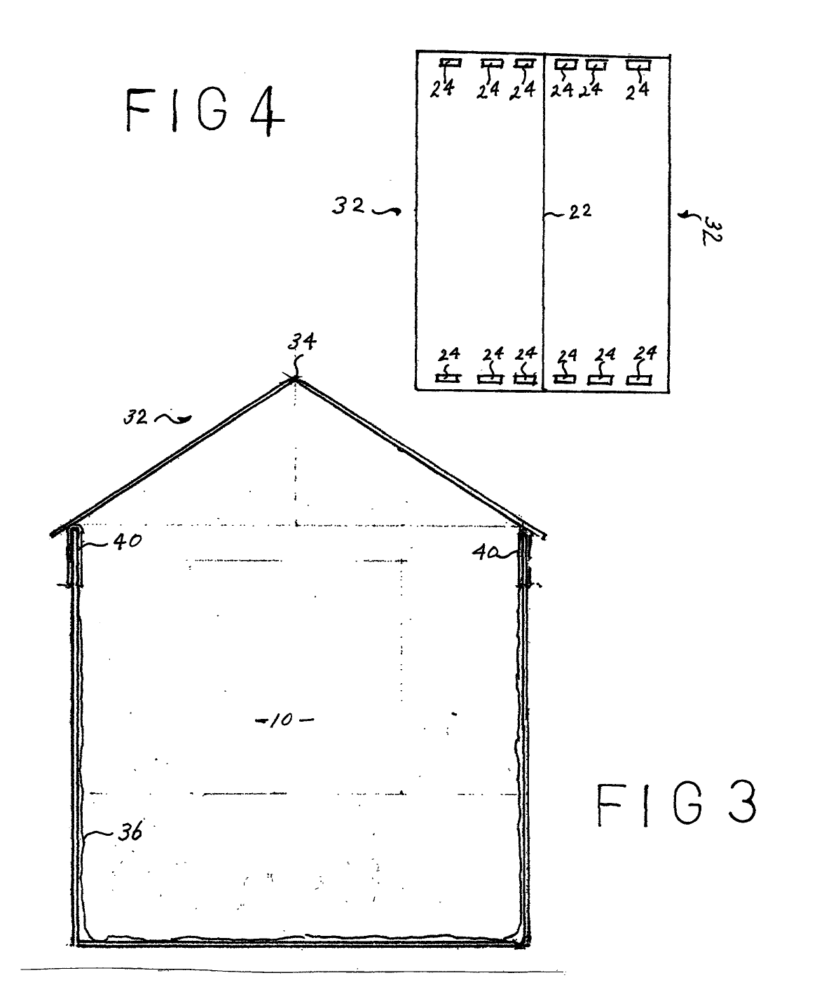

Referring now to the drawings, and particularly to FIG. 1 thereof, there is shown in plan the layout for a whelping or birthing pen which is generally identified by the numeral 10.

Pen 10 is provided with a floor 12, side walls 14 and 16 and end walls 18 and 20, which, in the preferred embodiment shown in the drawings are delineated by score markings 22 which facilitate forming the pen 10.

Side walls 14 and 16 are provided with a plurality of closure hooks 24 and end walls 18 and 20 are provided with a plurality of closure slots 26 which register with the hooks 24 for closure by sliding the hooks 24 through the slots 26 when the pen 10 is folded along the score markings 22. End walls 18 and 20 are provided with upwardly protruding tabs 28 for purposes which will hereinafter be disclosed. One of the end walls 18 is provided with an aperture 30 which serves as a raised door such that the mother may leave the pen 10 while the young remain safely closed within the pen 10. Various means may be used to close up a portion of the aperture 30 if the young grow to the point where they might otherwise jump out.

An elongated roof 32 is provided for pen 10 having a score 22 running longitudinally along the centerline such that roof 32 may be folded into an elongated peak 34. Adjacent each edge of the roof 32 remote from peak 34 there are provided a plurality of slots 24 adapted to receive tabs 28 when roof 32 is placed over pen 10. Note that tabs 28 are not shaped like the hooks 26 such that roof 32 may be readily and easily lifted off of pen 10. It should be equally well understood that the tabs 28 could be formed on the tops of side walls 14 and 16 and the slots 24 on the ends of roof 32 to register with tabs 28 to receive the roof 32.

One of the features of pen 10 is that it may be provided with a drape 36 suspended from the walls 14 and 16 to line the inside of pen 10. This drape could be linen, paper or other suitable material to permit easy removal of feces accumulated therein. This would be one reason for placing the tabs 28 and the slots 24 at the ends of the elongated roof 32 instead of along the portion of roof 32 adjacent sides 14 and 16. This would allow for various U-shaped clamps 40 to clamp the drape 36 in position within pen 10.

Since pen 10 is to be disposable it is contemplated that the floor 12, walls 14 and 16, end walls 18 and 20 and even the roof 32 would be formed from material such as cardboard, oyster board or the like and the inside surfaces of the pen 10 thus formed would be treated with a material resistant to absorption of moisture to reduce urine odors. It is not believed at this time that a safe treatment material or chemical is presently available which would altogether prevent absorption of liquids.

The edges of the sidewalls 14 and 16 and end walls 18 and 20 could also be joined by extruded plastic or aluminum slides adapted to receive the edges in grooves therein.

In any event it can be seen that the pen of the foregoing description accomplishes all of the objects, advantages previously set forth herein and they are intended to be covered by the scope of the appended claims.

1. A pen for raising a litter of the young of animals comprising;
a) a blank formed from foldable, firm material and provided with scores to define a floor, side walls and end walls;
b) means are provided for joining the edges of said side walls and end walls; and
c) an aperture in one of the end or side walls to permit the mother to have ingress and egress from the assembled pen to feed and clean the young and attend to her own needs.

2. The structure as set forth in claim 1, wherein said end walls are provided with hooks and said side walls are provided with slots adapted to complementarily engage with said hooks when said blank is folded along said scores.

3. The structure as set forth in claim 1, wherein said side walls are further provided with upwardly extending tabs on the edges remote from said floor.

4. The structure as set forth in claim 1, in further combination with an elongated roof structure scored along its longitudinal centerline axis to fold into an elongated peaked roof, said roof structure provided with a line of longitudinal slots adjacent the longitudinal edges of said roof remote from said score adapted to receive said tabs.

5. The structure as set forth in claim 1, wherein said end walls are provided with upwardly extending tabs and said roof is provided with slots adjacent to the latitudinal edges adapted to receive said tabs.

6. The structure as set forth in claim 1, wherein said floor, walls and ends are formed by folding along the score markings and from a firm cardboard material sufficiently porous to be impregnated with a water resistant chemical to inhibit absorption of urine.

7. The structure as set forth in claim 5 wherein said pen is provided with a drape adapted to be draped over the interior side wall and floor structure and to be clamped to the top edge of said side wall structure after being draped thereover.
